(19) United States
(12) Patent Application Publication
(10) Pub. No.: US 2008/0028512 A1
(43) Pub. Date: Feb. 7, 2008

(54) OPTICAL WATER SENSOR

(76) Inventor: Leslie Thomas Hughson, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/832,161

(22) Filed: Aug. 1, 2007

Related U.S. Application Data
(60) Provisional application No. 60/834,700, filed on Aug. 1, 2006.

(51) Int. Cl. A47K 3/10; H05B 1/02

(52) U.S. Cl. 4/541.3; 219/502; 392/485

(57) ABSTRACT

An improved heater for a spa bath is disclosed. The heater includes a body having an inlet and an outlet connectable to the pipe work of a bath for housing a heater element for heating water passing through the heater. The disclosed heater also includes an optical water sensor housed in the body for detecting the presence or absence of water in the heater body. The optical water sensor preferably includes a light source, a transmitting medium for transmitting light from the light source, and a light detector for detecting the light as transmitted through the transmitting medium whereby the transmission or internal reflection characteristics of the transmitting medium are affected by the contact of water to an external surface of the transmitting medium. A spa bath including the aforesaid heater is also described.

The present application claims the benefit of priority from U.S. Provisional Application No. 60/834,700, filed Aug. 1, 2006.

### FIELD OF THE INVENTION

The invention relates to an improved heating system for a bath or pool.

### BACKGROUND

A bath or pool such as a spa bath, also known as a hot tub or a Jacuzzi or spa pool, includes one or more water jets or in-ports for injecting or pumping water into the bath or pool (herein “bath” for convenience). Typically this water is heated and aerated.

Water is typically drawn from an outlet of the bath by a pump, is heated, and is returned to the bath.

The heater typically comprises an immersion resistance heating element which heats the water as it is circulated through pipe work around the bath, from the outlet to the inlets. It is desirable to avoid burn out of the heater element and possible damage to the bath or associated componentry, from running of the heater in the absence of water.

### SUMMARY OF THE INVENTION

In one aspect the invention consists in an improved heater for a spa bath or pool (herein “bath”) comprising or including:

a heater body having an inlet and an outlet connectable to the pipe work of a bath, housing a heater element for heating water passing through the heater, and

an optical water sensor mounted in the housing for detecting the presence or absence of water in the heater body.

Preferably the optical water sensor comprises or includes:

a light source or LED,

a transmitting medium for transmitting light from the light source, and

a light detector or phototransistor capable of detecting the light as transmitted through the transmitting medium whereby the transmission or internal reflection characteristics of the transmitting medium are affected by the contact of water to an external surface of the transmitting medium.

Preferably the detection of light by the light detector corresponds to the absence or non-contact of water.

Preferably the reflection of the light in the transmitting medium is caused by contact of water with an external surface of the transmitting medium such that a substantial amount of light from the light source is not reflected towards the light detector.

Preferably the transmitting medium is substantially triangular in section and the LED and photo transistor are positioned opposite along a central axis of the triangle.

Preferably the transmitting medium is cone shaped wherein the LED and photo transistor are positioned opposite across a central axis of the cone shape.

Preferably the LED and photo transistor are electrically connected in parallel (preferably with a common ground).

Preferably separate voltages are applied to the LED and photo transistor whereby the reception of light in the photo transistor corresponds to an increase in current flow through the photo transistor which may be measured or detected by an external circuit or meter or the like.

Preferably a threaded casing surrounds the optical water sensor extending from the base of the transmission medium backwards, a water tight seal existing between the threaded casing and the transmission medium.

Preferably the transmission medium of the optical water sensor projects at least partially and preferably substantially through the body of the heating system and into a cavity defined therein.

Preferably the control system, in the absence of water as detected by the optical water sensor, turns the heating element off.

In another aspect the invention consists in a spa bath comprising or including:

a heating system through which water from the spa bath can be re-circulated,

an optical water sensor in or on a body of the heating system capable of detecting the presence of water in the heating system.

Definitions

As used herein the term “and/or” means “and” or “or”, or both.

As used herein the term “(s)” following a noun means the singular and/or plural forms of that noun.

The phrase ‘comprising or including’ as used in this specification means ‘consisting at least in part of’, that is to say when interpreting statements in this specification which include that term, the features, prefaced by that term in each statement, all need to be present but other features can also be present.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE FIGURES

The invention is further described with reference to the accompanying figures which show a preferred form by way of example.

FIG. 1 is a longitudinal cross-section view through one embodiment of a heater unit for a spa bath,

FIG. 2 shows an optical water sensor removed from the heater tube of the heater unit,

FIG. 3 schematically shows internal componentry of the optical water sensor unit removed from its external sensor head case,

FIG. 4 is a view of the internal componentry of the optical water sensor in the direction of arrow A of FIG. 3,

FIGS. 5a and 5b schematically show operation of the optical water sensor as will be further described,

FIG. 6 represents the optical water sensor as a simple electrical circuit diagram,

FIG. 7 is a cross-section view of another embodiment of a heater unit for a spa bath.

### DETAILED DESCRIPTION OF THE INVENTION

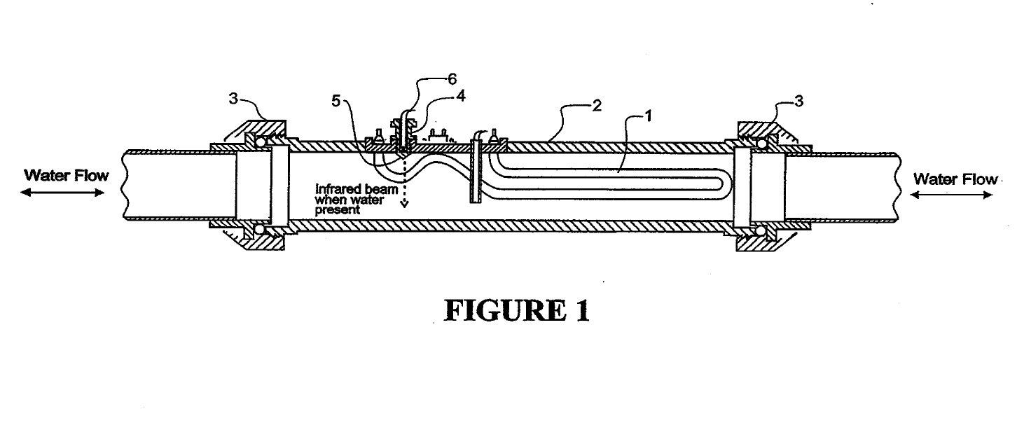

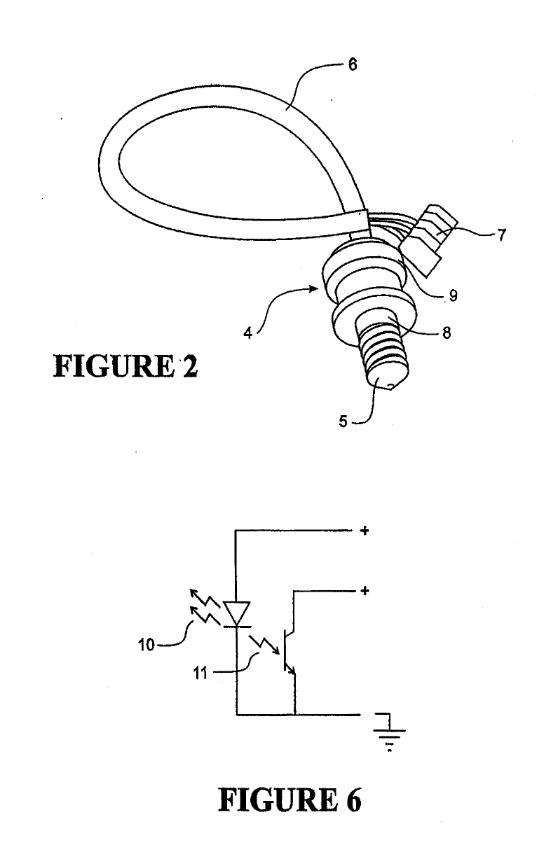

FIG. 1 shows a heater unit for a spa bath, comprising an electric heating element 1 for heating water which in operation of the spa bath is pumped through a pipe or tube 2 (herein referred to as a heater tube) of the heater. In the preferred form the heater tube 2 is threaded at its either end for connection into the pipe work of the spa bath via threaded couplings 3. An optical water sensor unit 4 as separately shown in FIG. 2 is threadedly mounted in an aperture in the side wall of the heater tube 2 as shown, so that the optical tip 5 (see in particular FIG. 2) of the water sensor unit 4 is normally exposed to water pumped through the heater tube 2 in operation of the spa bath. Wires 6 from the optical sensor unit 4 connect to a control system of the spa bath, in the preferred form via a plug 7 (see FIG. 2).

Typically the sensor unit is formed by plastic moulding, with a threaded exterior part 8 for mounting the sensor head into a threaded port in the wall of the heater tube, 4 preferably with a surrounding O-ring 9.

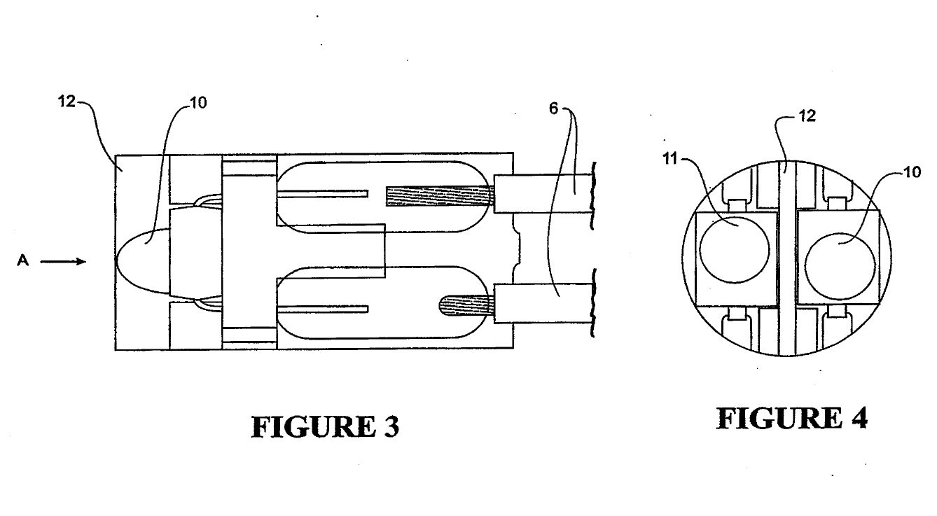

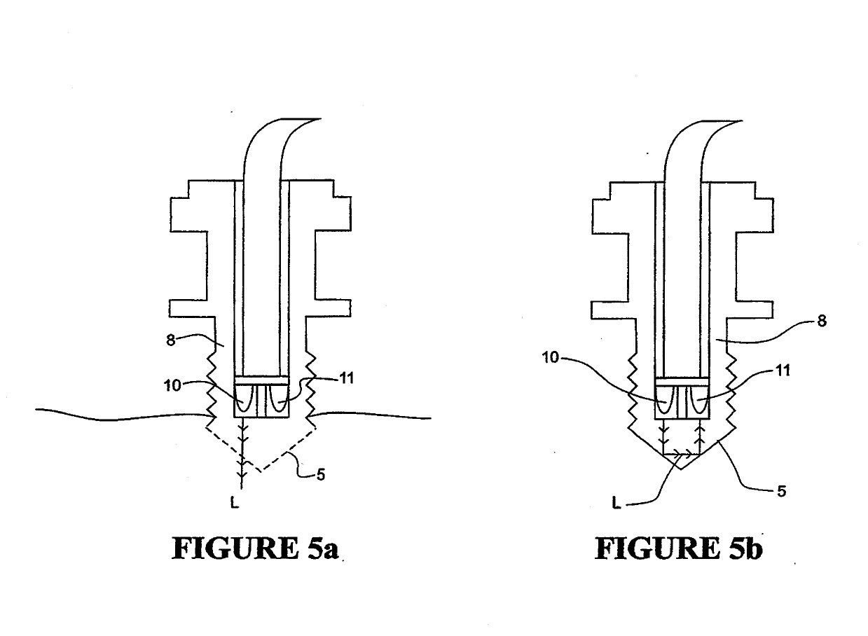

FIGS. 3 and 4 show the internal componentry within the water sensor unit 4. LED 10 and photo transistor 11 (or photo diode) are mounted on either side of an opaque partition 12. The tip 5 of the sensor unit 4 in the preferred form is conically shaped as shown and is transparent (or at least translucent). When water is present in the heater tube 2 such that water contacts the tip 5 of the sensor unit 4, light from LED 10 (which is on when the spa bath control system is on) is refracted at the boundary between the transparent material of the sensor tip 5 and water, and is not reflected back to the photo transistor 11. When water is not present, light is reflected at the boundary of the sensor tip 5 and air in the heater tube, through two 90 degree angles within the light transmitting material of the sensor tip 5, and back to the photo transistor 11, initiating a signal from the photo transistor 11 which is recognised by the control system as a “no water” signal. In turn the control system 11 is arranged to disconnect power to the heater element 1, to protect the heater element from burning out. FIG. 6 represents the LED 10 and photo transmitter 11 as a simple electrical circuit diagram. This is schematically represented in FIGS. 5a and 5b. Referring to FIG. 5a, in the presence of water light from LED 10 represented by beam L is refracted at the boundary between the material of the sensor tip 5 and water surrounding the sensor tip, and does not reach the photo transistor 11. Referring to FIG. 5b, in the absence of water light is reflected within the material of the tip 5 through two 90 degree angles back to the photo transistor 11, initiating a “no water” signal.

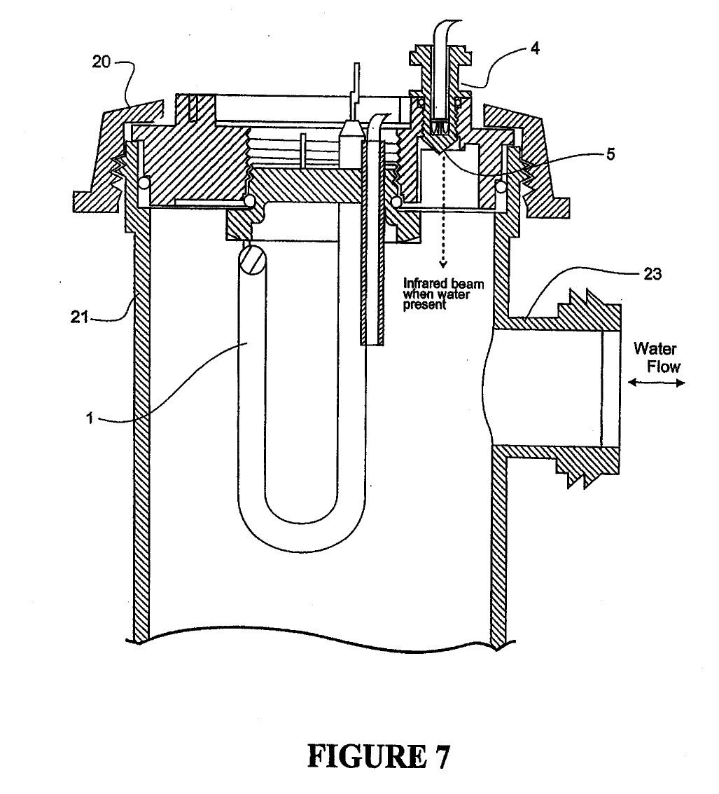

FIG. 7 shows another embodiment of a heater unit, in which the heater element is mounted in a cap 20 which fits onto a heater body 21. Water enters and exits the interior of the heater body 21 through port 23 which is connected to the pipe work of the bath. The optical water sensor 4 is similarly threaded into an aperture in the cap 20 as shown, so that in normal operation when the interior of the heater body is filled with water the tip 5 of the water sensor will be in contact with water but absent water a “no water” signal would be provided to the control system of the bath.

The foregoing describes a preferred form. Alterations and modifications as would be obvious to those skilled in the art are intended to be incorporated in the scope thereof.

1. A heater for a spa bath or pool (herein “bath”), comprising:
a heater body having an inlet and an outlet, or a common inlet and outlet, connectable to the pipe work of a bath, housing a heater element for heating water passing through the heater, and
an optical water sensor mounted in the heater body for detecting the presence or absence of water in the heater body.

2. A heater according to claim 1 wherein the optical water sensor comprises an LED or other light source and an associated transmitting medium arranged to transmit light towards the interior of the heater body through which water passes, and having transmission or internal reflection characteristics which are affected by contact of an exposed external surface part of the transmitting medium with water within the interior of the heater body, and a phototransistor or other light detector to detect light transmitted from the transmitting medium in one or other of the absence or presence of water.

3. A heater according to claim 2 wherein the transmitting medium is substantially triangular in section and the LED or other light source and phototransistor or other light detector are positioned on opposite sides of a central axis of the triangular section.

4. A heater according to claim 3 wherein the transmitting medium is cone-shaped.

5. A heater according to claim 2 wherein the optical water sensor comprising the LED or other light source and phototransistor or other light detector is formed as a sealed unit which removably threads into a threaded aperture in the heater body.

6. A heater according to claim 1 wherein the heater body is in the overall form of a hollow conduit or pipe which can be installed in series with pipework carrying water to and/or from the bath, and is formed at its either end to facilitate connection of the heater body to such pipe work.

7. A heater according to claim 6 wherein a part of the heater body around each of the inlet and outlet or around a common inlet and outlet is formed so as to facilitate a threaded connection of the heater body to the pipe work of a bath.

8. A heater for a spa bath or pool (herein “bath”), comprising:
a heater body having an inlet and an outlet, or a common inlet and outlet, connectable to the pipe work of a bath, housing a heater element for heating water passing through the heater, and
an optical water sensor mounted in the heater body for detecting the presence or absence of water in the heater body, the optical water sensor comprising an LED or other light source and an associated transmitting medium arranged to transmit light towards the interior of the heater body through which water passes, and having transmission or internal reflection characteristics which are affected by contact of an exposed external surface part of the transmitting medium with water within the interior of the heater body, and a phototransistor or other light detector to detect light transmitted from the transmitting medium in one or other of the absence or presence of water.

9. A heater according to claim 8 wherein the transmitting medium is substantially triangular in section and the LED or other light source and phototransistor or other light detector are positioned on opposite sides of a central axis of the triangular section.

10. A heater according to claim 8 wherein the heater body is in the overall form of a hollow conduit or pipe which can be installed in series with pipework carrying water to and/or from the bath, and is formed at its either end to facilitate connection of the heater body to such pipe work.

11. A heater according to claim 10 wherein a part of the heater body around each of the inlet and outlet or around a common inlet and outlet is formed so as to facilitate a threaded connection of the heater body to the pipe work of a bath.

12. A heater for a spa bath or pool (herein “bath”), comprising:
a heater body having an inlet and an outlet, or a common inlet and outlet, connectable to the pipe work of a bath, housing a heater element for heating water passing through the heater, the heater body being in the overall form of a hollow conduit or pipe which can be installed in series with pipework carrying water to and/or from the bath, and is formed at its either end to facilitate connection of the heater body to such pipe work, and
an optical water sensor mounted in the heater body for detecting the presence or absence of water in the heater body, the optical water sensor comprising an LED or other light source and an associated transmitting medium arranged to transmit light towards the interior of the heater body through which water passes, and having transmission or internal reflection characteristics which are affected by contact of an exposed external surface part of the transmitting medium with water within the interior of the heater body, and a phototransistor or other light detector to detect light transmitted from the transmitting medium in one or other of the absence or presence of water.

13. A heater according to claim 12 wherein the transmitting medium is substantially triangular in section and the LED or other light source and phototransistor or other light detector are positioned on opposite sides of a central axis of the triangular section.

14. A spa bath comprising a heater as claimed in claim 1.

15. A spa bath comprising a heater as claimed in claim 8.

16. A spa bath comprising a heater as claimed in claim 12.
